(19) United States
(12) Patent Application Publication
(10) Pub. No.: US 2026/0340793 A1
(43) Pub. Date: Oct. 29, 2026

(54) PROJECTION IMAGE CORRECTION METHOD AND PROJECTION DEVICE

(71) Applicant: Anker Innovations Technology Co., Ltd., Shenzhen (CN)

(72) Inventors: Yang Zhang, Shenzhen (CN); Yifeng Xie, Shenzhen (CN); Xiao Li, Shenzhen (CN); Xiao Liu, Shenzhen (CN)

(21) Appl. No.: 19/653,885

(22) Filed: Apr. 21, 2026

(30) Foreign Application Priority Data
Apr. 23, 2025 (CN) 202510522984.8

(51) Int. Cl. G06T 5/80; G06T 7/194; G06T 7/73; G09G 3/00

(52) U.S. Cl. CPC G06T 5/80; G06T 7/194; G06T 7/74; G09G 3/002; G09G 2354/00

(57) ABSTRACT

The present application relates to a projection image correction method and a projection device. The method includes capturing, by a projection device a reference projection image in response to a correction operation on a projection image; storing, by the projection device, correction state information of the reference projection image when the correction operation is re-triggered; generating, by the projection device, based on the stored correction state information, and the projection image after re-triggered correction, a target projection image; and projecting, by the projection device and on a projection plane, the target projection image.

### CROSS-REFERENCE TO RELATED APPLICATION

The present application claims priority to CN Application No. 202510522984.8, filed on Apr. 23, 2025. The above application is incorporated by reference in its entirety.

### FIELD

The present application relates to the field of projection technology, and more particularly to a projection image correction method and a projection device.

### BACKGROUND

As projection devices become increasingly more intelligent, the projection images can be adjusted during projection by virtue of environmental perception algorithms. However, even after such adjustment, it may be difficult for the projection image to fully match an ideal geometric state.

In related technologies, based on adjustment by the environmental perception algorithms, users may further fine-tune the adjusted projection images through mechanical pan-tilt angle adjustment or optical zooming operations. At this time, the user's fine-tune operation may simultaneously triggers an automatic keystone correction function; that is, the fine-tune operation may include a user's manual operation and a keystone correction operation.

However, because the keystone correction process performs independent calculations based on real-time sensor data, a user-defined throw ratio may be forcibly reset and a previously avoided obstacle area may re-enter a frame.

### SUMMARY

In view of the above technical problems, it is necessary to provide a projection image correction method and a projection device to prevent a user-defined throw ratio from being forcibly reset and a previously avoided obstacle area from re-entering a frame.

In a first aspect, the present application provides a projection image correction method, including: correcting, by a projection device, a projection image to obtain a reference projection image in response to a correction operation on the projection image. For example, the projection device may capture a reference projection image in response to the correction operation on the projection image. The method may also include obtaining and storing correction state information of the reference projection image when the correction operation is re-triggered. The method may further include generating or correcting, based on the correction state information, the projection image after the re-triggered correction operation, the projection image to obtain a target projection image. The method may still include projecting, by the projection device and on a projection plane, the target projection image.

In one example, the correction state information includes a throw distance of a target projection area and a projection angle of the projection device, and a method for the re-triggered correction includes throw ratio and/or keystone correction.

In one example, the method for the re-triggered correction includes keystone correction, and a situation for the re-triggered correction includes: adjusting the reference projection image, and re-triggering the keystone correction when a change in the projection angle and/or throw distance triggers the correction operation.

In one example, the method for the re-triggered correction includes throw ratio correction, and a situation for the re-triggered correction includes: adjusting the reference projection image, and re-triggering the throw ratio correction when a change in the throw distance and/or projection angle triggers the correction operation.

In one example, the projection angle includes pose information of the projection device, and the correcting, based on the correction state information, the projection image after re-triggered correction, to obtain a target projection image, includes: obtaining a projection environment image of the projection device under the pose information, and determining an obstacle area in the projection environment image; determining the target projection area in the projection environment image, where the target projection area is an image area that avoids the obstacle area; and forming the target projection image by projection on a target projection area.

In one example, the correction state information further includes coordinate information of a calibration pattern in the reference projection image, and the projection angle includes pose information of the projection device; the obtaining correction state information of the reference projection image includes: obtaining an initial pose of the projection device that forms the projection image, and initial coordinate information of a calibration pattern in the projection image; and determining the coordinate information of the calibration pattern in the reference projection image based on the initial pose, the initial coordinate information, and a reference pose of the projection device that forms the reference projection image.

In one example, the determining the coordinate information of the calibration pattern in the reference projection image based on the initial pose, the initial coordinate information, and a reference pose of the projection device that forms the reference projection image includes: determining a throw distance deviation and an attitude deviation of the projection device based on the initial pose and the reference pose; determining a coordinate deviation of the projection image based on the throw distance deviation and the attitude deviation; and determining the coordinate information of the calibration pattern in the reference projection image based on the coordinate information of the calibration pattern in the projection image and the coordinate deviation of the projection image.

In one example, the method further includes: determining, based on an awakened projection angle and a reference projection angle of the projection device, whether to correct an awakened projection image of the projection device when the projection device is awakened; using the awakened projection image as the projection image when correction is required, and executing the step of correcting a projection image to obtain a reference projection image in response to a correction operation on the projection image; and using the awakened projection image as the target projection image when correction is not required.

In one example, the determining, based on an awakened projection angle and a reference projection angle of the projection device, whether to correct an awakened projection image of the projection device includes: obtaining an angle variation between the awakened projection angle and the reference projection angle; determining that correction is required when the angle variation is greater than or equal to a preset variation threshold; and determining that correction is not required when the angle variation is less than the preset variation threshold.

In a second aspect, the present application further provides a projection device, including a memory and one or more processors, where the memory stores computer-readable instructions that, when executed by the one or more processors of the projection device, configure the projection device to implement any example projection image correction method in the first aspect.

According to the projection image correction method and the projection device, the projection image is corrected to obtain the reference projection image in response to the correction operation on the projection image; the correction state information of the reference projection image is obtained when the correction operation is re-triggered; and the projection image after re-triggered correction is corrected based on the correction state information to obtain the target projection image. The method determines the correction state information based on the reference projection image obtained by previous correction, and corrects the projection image by using the correction state information in case of re-triggered correction, achieving re-correction based on a previous correction result. The use of the previous correction result in case of re-triggered correction can prevent a user-defined throw ratio from being forcibly reset and a previously avoided obstacle area from re-entering a frame, thereby improving the correction effect.

### BRIEF DESCRIPTION OF THE DRAWINGS

In order to illustrate technical solutions in examples of the present application or the related art more clearly, the accompanying drawings required in the description of the examples of the present application or the related art will be briefly introduced below. Apparently, the drawings described below show merely some examples of the present application. A person of ordinary skill in the art may also derive other related drawings based on these drawings without any creative efforts.

FIG. 1 is an application environment diagram of a projection image correction method in an example;

FIG. 2 is a schematic flowchart of a projection image correction method in an example;

FIG. 3 is a schematic flowchart of a projection image correction method in an example;

FIG. 4 is a schematic flowchart of a projection image correction method in an example;

FIG. 5 is a schematic flowchart of a projection image correction method in an example;

FIG. 6 is a schematic flowchart of a projection image correction method in an example;

FIG. 7 is a schematic flowchart of a projection image correction method in an example;

FIG. 8 is a schematic flowchart of a projection image correction method in an example;

FIG. 9 is a schematic flowchart of a projection image correction method in an example; and

FIG. 10 is a structural block diagram of a projection image correction apparatus in an example.

### DETAILED DESCRIPTION

In order to make the objectives, technical solutions, and advantages of the present application clearer, the present application will be further described in detail below in conjunction with the accompanying drawings and examples. It should be understood that the specific examples described herein are merely used to explain the present application, but not to limit the present application.

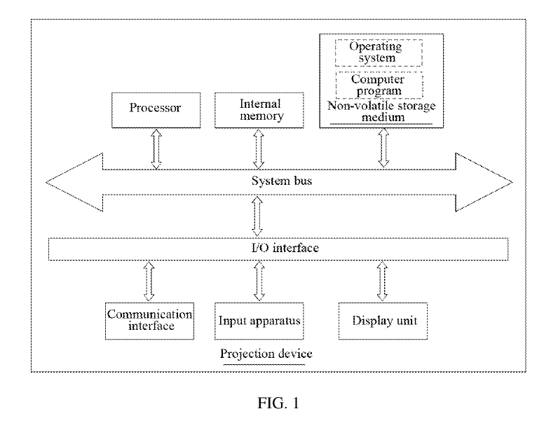

A projection image correction method provided in the examples of the present application can be applied to an application environment shown in FIG. 1. The application environment includes a projection device, and the projection device includes a processor, a memory, a communication interface, a display unit, and an input apparatus connected through a system bus. The processor of the projection device is configured to provide computing and control capabilities. The memory of the projection device includes a non-volatile storage medium and an internal memory. The non-volatile storage medium stores an operating system and a computer program. The internal memory provides an environment for running of the operating system and the computer program in the non-volatile storage medium. The communication interface of the projection device is configured for wired or wireless communication with an external terminal device. The wireless communication can be implemented through WIFI, mobile cellular networks, or other technologies. The computer program is executed by the processor to implement a projection image correction method. The display unit of the projection device may be a liquid crystal display screen or an electronic ink display screen. The input apparatus of the projection device may be a touch layer covering the display unit, or a button, trackball or touchpad arranged on a housing of the projection device, or an external keyboard, touchpad, remote controller or mouse.

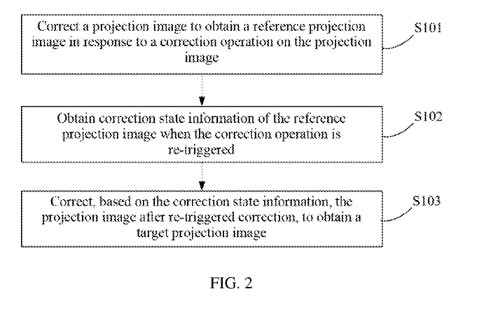

In an exemplary example, as shown in FIG. 2, a projection image correction method is provided. The method is applied to the processor in FIG. 1 as an example for explanation, including the following steps 101 to 103.

S101: a computing device (e.g., a controller remote to the projection device) or a projection device may correct a projection image to obtain a reference projection image in response to a correction operation on the projection image. For example, the reference projection image may be captured in response to the correction operation on the projection image.

The projection image is generated by the projection device in an initial state. It should be noted that the projection image has been corrected by an environmental perception algorithm. For example, the environmental perception algorithm may be a spatial adaptation, image adaptation, or intelligent obstacle avoidance algorithm.

In the examples of the present application, after the projection device is started, the projection device presents the projection image on a projection plane that has been corrected by the environmental perception algorithm. At this point, due to possible angular deviations and inconsistent distances between the projection device and the projection plane or due to optical calibration issues of the projection device, the projection image may exhibit phenomena such as keystone distortion, image offset, and disproportion. A user may then perform a correction operation through a remote controller or control terminal associated with the projection device, may directly adjust a mechanical pan-tilt angle or optical focal length in the projection device, or may translate or scale the projection image through a digital adjustment algorithm, so that, after the correction operation, the corrected projection image can meet user's projection needs. The corrected projection image is taken as the reference projection image.

For example, the correction operation may be triggered based on a user's adjustment operation or automatically triggered based on a state of the projection device itself. For example, in response to shaking of the projection device, the correction operation on the projection image may be triggered.

S102: the computing device or the projection device may obtain or store correction state information of the reference projection image when the correction operation is re-triggered. The re-triggered correction operation may be the same as or different from the previous correction operation. In an example, a method for the re-triggered correction includes zooming and/or keystone correction.

In one example, the correction state information includes a projection angle and a throw distance. The method for the re-triggered correction includes keystone correction, and a situation for the re-triggered correction includes: adjusting the reference projection image, and re-triggering the keystone correction when a change in the projection angle and/or throw distance triggers the correction operation.

In one example, the correction state information includes a throw distance and a projection angle. The method for the re-triggered correction includes zooming, and a situation for the re-triggered correction includes: adjusting the reference projection image, and re-triggering the zooming when a change in the throw distance and/or projection angle triggers the correction operation. In an example, when the projection device forms the reference projection image, correction is re-triggered, and the projection device obtains a state parameter of the reference projection image as the correction state information.

Additionally, the correction state information of the reference projection image further includes coordinate information, the coordinate information may be information of four vertices of a calibration pattern in the reference projection image, and the coordinate information may be represented as Pn(xn1, yn1, xn2, yn2, xn3, yn3, xn4, yn4). The throw distance of a target projection area includes a distance Df between the projection device and the reference projection image, and the projection angle of the projection device includes a pitch angle αn, a yaw angle βn, and a roll angle γn.

After obtaining the reference projection image, the user may select through the remote controller or terminal device whether to trigger a throw ratio and/or keystone correction. If the user selects to trigger the throw ratio and/or keystone correction, the user may continue to perform a throw ratio and/or keystone correction operation on the reference projection image. If the user selects not to trigger the throw ratio and/or keystone correction, the reference projection image is taken as a target projection image.

Alternatively, whether to trigger the throw ratio and/or keystone correction can be determined based on a correction operation method for the projection image. Specifically, the processor can compare the reference projection image with the projection image to determine a type of the correction operation, and determine whether to trigger the throw ratio and/or keystone correction according to the type of the correction operation. Taking a keystone correction process as an example, if the user translates or scales the projection image through digital adjustment to obtain the reference projection image, the keystone correction may not be triggered; and if the user adjusts a pan-tilt angle of the projection device or performs optical zooming through physical adjustment to obtain the reference projection image, the keystone correction may be triggered.

In the examples of the present application, after it is determined that the throw ratio and/or keystone correction have been triggered, the processor can send an image capture instruction to an image capture device integrated inside the projection device, and the image capture device may capture the reference projection image and send the reference projection image to the processor. The processor can recognize coordinates of each vertex of the calibration pattern in the reference projection image by using an image recognition algorithm, to obtain coordinate information of the calibration pattern in the reference projection image. Alternatively, the processor can determine user's manually adjusted coordinate information of the calibration pattern in the reference projection image based on coordinate information of a calibration pattern in the projection image, pose information of the projection device that forms the projection image, and user's manually adjusted pose change information.

The processor can alternatively send a capture instruction to a time of flight sensor (TOF) and a gyro sensor (Gsensor). The TOF captures a throw distance of the target projection area, and then sends the throw distance to the processor. Similarly, the Gsensor captures a pitch angle, a yaw angle, and a roll angle of the projection device that form the reference projection image, and then sends the pitch angle, the yaw angle, and the roll angle to the processor, and the processor uses the obtained pitch angle, yaw angle, and roll angle as projection angles of the projection device.

S103: the computing device or the projection device may correct or generate, based on the correction state information, the projection image after re-triggered correction, to obtain a target projection image.

In an example, after obtaining the correction state information of the projection device and after the re-triggered correction, the projection device can perform, based on the correction state information, a corresponding correction operation on the projection image after re-triggered correction, to obtain the target projection image. The target projection image may be projected on a projection plane by the projection device.

In the above projection image correction method, the projection image is corrected to obtain the reference projection image in response to the correction operation on the projection image; the correction state information of the reference projection image is obtained when the correction operation is re-triggered; and the projection image after re-triggered correction is corrected based on the correction state information to obtain the target projection image. The method determines the correction state information based on the reference projection image obtained by previous correction, and corrects the projection image by using the correction state information in case of re-triggered correction, achieving re-correction based on a previous correction result. The use of the previous correction result in case of re-triggered correction can prevent a user-defined throw ratio from being forcibly reset and a previously avoided obstacle area from re-entering a frame, thereby improving the correction effect.

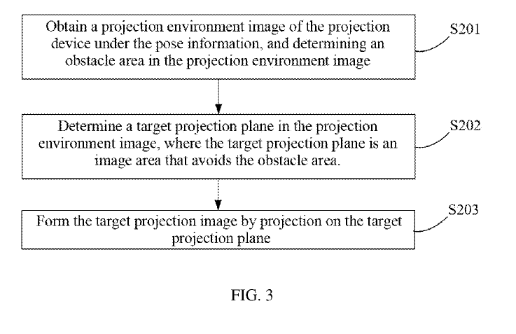

The projection angle in the correction state information includes pose information of the projection device. In one example, as shown in FIG. 3, the specific content of correcting, based on the correction state information, the projection image after re-triggered correction, to obtain a target projection image is introduced. The specific content includes the following steps.

S201: a computing device or a projection device may obtain a projection environment image of the projection device under the pose information, and determine an obstacle area in the projection environment image.

The pose information of the projection device includes attitude data of the projection device. For example, the attitude data includes at least one of a side throw angle, a pitch angle, and a roll angle of the projection device. In an example, the projection device can obtain the projection environment image under the pose information in the correction state information through the image capture device, and perform obstacle detection on the projection environment image to determine the obstacle area where obstacles exist in the projection environment image.

S202: the computing device or the projection device may determine a target projection area in the projection environment image, where the target projection area is an image area that avoids the obstacle area.

In an example, after determining the obstacle area in the projection environment image, the projection device can avoid the obstacle area in the projection environment image to obtain the target projection area. For example, the projection device can determine a non-obstacle area in the projection environment image that avoids the obstacle area, and determine a largest horizontal rectangular area in the non-obstacle area as the target projection area.

S203: the computing device or the projection device may form the target projection image by projection on the target projection area.

In an example, after obtaining the target projection area in the projection environment image, the projection device can adjust the pose information for projection on the target projection area to form the target projection image that matches the target projection area in position and size.

In the above projection image correction method, the projection environment image of the projection device under the pose information is obtained, and the obstacle area in the projection environment image is determined; the target projection area is determined in the projection environment image, where the target projection area is the image area that avoids the obstacle area; and the target projection image is formed by projection on the target projection area. This method avoids obstacles in the projection environment image to determine the target projection area therefrom, and forms the target projection image by projection on the target projection area, thereby achieving obstacle avoidance projection, reducing the interference of obstacles on the projection image, and improving the projection effect.

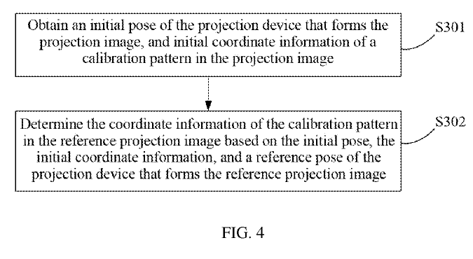

Assuming that the correction state information further includes coordinate information of a calibration pattern in the reference projection image, and the projection angle includes pose information of the projection device, in one example, as shown in FIG. 4, the specific content of obtaining correction state information of the reference projection image includes the following steps.

S301: a computing device or a projection device may obtain an initial pose of the projection device that forms the projection image, and initial coordinate information of a calibration pattern in the projection image.

The initial pose refers to a pose of the projection device that has been corrected by the environmental perception algorithm. The initial pose includes a distance D0 between the projection device and the projection image, a pitch angle α0, a yaw angle β0, and a roll angle γ0 of the projection device. The initial coordinate information may be information of four vertices of the projection image, and may represented as P0 (x01, y01, x02, y02, x03, y03, x04, y04).

In the examples of the present application, if the initial coordinate information of the calibration pattern in the projection image that has been corrected by the environmental perception algorithm and the initial pose of the projection device that forms the projection image have been stored in a database, the processor can search the database based on identification information of the projection image for the initial coordinate information of the calibration pattern in the projection image and the initial pose of the projection device that forms the projection image. Alternatively, after obtaining the projection image through correction by the environmental perception algorithm, the processor can send an image capture instruction to the image capture device integrated inside the projection device, and the image capture device will capture the projection image and send the projection image to the processor. The processor can recognize coordinates of each vertex in the projection image by using an image recognition algorithm, to obtain coordinate information of the calibration pattern in the projection image.

Meanwhile, if the initial pose of the projection device that forms the projection image is all stored in the database, the processor can further search the database based on the identification information of the projection image for pose information corresponding to the identification information, i.e., the initial pose of the projection device that forms the projection image. Alternatively, the processor can send a capture instruction to a TOF or a Gsensor. The TOF captures a distance between the projection image and the projection device and sends the distance to the processor. After capturing a pitch angle, a yaw angle, and a roll angle of the projection device that form the projection image, the Gsensor sends the pitch angle, the yaw angle, and the roll angle to the processor, and the processor uses the obtained distance, pitch angle, yaw angle, and roll angle as the initial pose of the projection device that forms the projection image.

S302: the computing device or the projection device may determine the coordinate information of the calibration pattern in the reference projection image based on the initial pose, the initial coordinate information, and a reference pose of the projection device that forms the reference projection image.

In the examples of the present application, the processor can compare the initial pose of the projection device with the reference pose to determine a pose change value of the projection device during user's manual adjustment, then determine a coordinate change value of the projection image during user's manual adjustment based on a mapping relationship between the pose change value and a coordinate change value, and determine the coordinate information of the calibration pattern in the reference projection image based on the coordinate change value of the projection image and the initial coordinate information.

Alternatively, the processor can input the initial pose, the reference pose, and the initial coordinate information of the calibration pattern in the projection image into a preset neural network model, and use the preset neural network model for analysis to determine the coordinate information of the calibration pattern in the reference projection image.

In the above projection image correction method, the initial pose of the projection device that forms the projection image and the initial coordinate information of the calibration pattern in the projection image are obtained; and the coordinate information of the calibration pattern in the reference projection image is determined based on the initial pose, the initial coordinate information, and the reference pose of the projection device that forms the reference projection image. After obtaining the initial pose and the initial coordinate information, this method compares the initial pose with the reference pose to accurately determine a pose variation of the projection device during manual adjustment, and combines the pose variation and an initial position to accurately determine the coordinate information of the calibration pattern in the reference projection image.

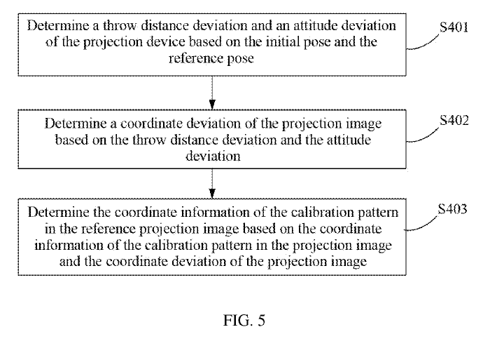

In one example, as shown in FIG. 5, a method of determining the specific content of the coordinate information of the calibration pattern in the reference projection image based on the initial pose, the initial coordinate information, and a reference pose of the projection device that forms the reference projection image is introduced. The method includes the following steps.

S401: a computing device or a projection device may determine a throw distance deviation and an attitude deviation of the projection device based on the initial pose and the reference pose.

The throw distance deviation refers to a distance variation between the projection device and the projection image during user's manual adjustment. The attitude deviation refers to an angle variation during user's manual adjustment.

In the examples of the present application, both the initial pose of the projection device that forms the projection image and the reference pose of the projection device that forms the reference projection image include a throw distance of the projection device and an attitude of the projection device, where the throw distance is a distance between the projection device and the projection image. The processor can then calculate a distance difference between a reference throw distance in the reference pose and an initial throw distance in the initial pose, and use this distance difference as the throw distance deviation of the projection device. Meanwhile, the processor can also calculate an attitude difference between a reference attitude in the reference pose and an initial attitude in the initial pose, and use this attitude difference as the attitude deviation of the projection device.

It should be noted that the reference attitude in the reference pose includes a reference pitch angle, a reference yaw angle, and a reference roll angle, and the initial attitude in the initial pose includes an initial pitch angle, an initial yaw angle, and an initial roll angle. Then, the attitude deviation of the projection device includes a pitch angle deviation, a yaw angle deviation, and a roll angle deviation.

S402: the computing device or the projection device may determine a coordinate deviation of the projection image based on the throw distance deviation and the attitude deviation. The coordinate deviation refers to a difference between coordinates of the reference projection image and coordinates of the projection image.

In the examples of the present application, there is a certain mapping relationship between the throw distance deviation, the attitude deviation, and the coordinate deviation. The processor can map the throw distance deviation and the attitude deviation based on this mapping relationship, to obtain a coordinate deviation corresponding to the throw distance deviation and the attitude deviation, e.g., the coordinate deviation of the projection image during user's manual adjustment.

S403: the computing device or the projection device may determine the coordinate information of the calibration pattern in the reference projection image based on the coordinate information of the calibration pattern in the projection image and the coordinate deviation of the projection image.

In the examples of the present application, after obtaining the coordinate deviation of the projection image, the processor can use the coordinate deviation of the projection image to adjust the coordinate information of the calibration pattern in the projection image, and use the adjusted coordinate information as the coordinate information of the calibration pattern in the reference projection image.

In the above projection image correction method, the throw distance deviation and attitude deviation of the projection device are determined based on the initial pose and the reference pose; the coordinate deviation of the projection image is determined based on the throw distance deviation and the attitude deviation; and the coordinate information of the calibration pattern in the reference projection image is determined based on the coordinate information of the calibration pattern in the projection image and the coordinate deviation of the projection image. By comparing the initial pose that forms the projection image with the reference pose that forms the reference projection image, this method can accurately determine the throw distance deviation and the attitude deviation when the user adjusts the projection device, thereby accurately determining the coordinate deviation of the projection image by using the deviation information of the projection device. By combining the coordinate deviation and the coordinate information of the calibration pattern in the projection image, the coordinate information of the calibration pattern in the reference projection image can be accurately determined.

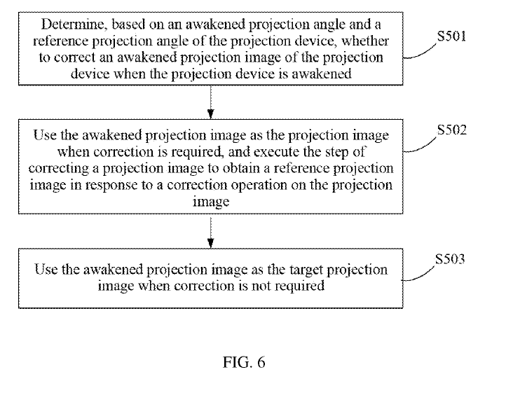

After the correction of the projection image is completed, the projection device is turned off. After a certain interval, the projection device is reawakened. In one example, as shown in FIG. 6, a detailed explanation is provided on whether the projection device needs to be further corrected after being reawakened. The method includes the following steps.

S501: a computing device or a projection device may determine, based on an awakened projection angle and a reference projection angle of the projection device, whether to correct an awakened projection image of the projection device when the projection device is awakened.

The reference projection angle of the projection device refers to a projection angle of the projection device that forms the target projection image. Assuming that the correction process of the projection image includes correction using an environmental perception algorithm, the reference projection angle refers to an initial projection angle of the projection device that forms the projection image. Assuming that the correction process of the projection image includes correction using an environmental perception algorithm and user's manual correction, the reference projection angle refers to a reference projection angle of the projection device that forms the reference projection image. Assuming that the correction process of the projection image includes correction using an environmental perception algorithm, user's manual correction, and keystone correction, the reference projection angle refers to an attitude of the projection device that forms the target projection image.

In the examples of the present application, the projection device may be awakened after being restarted or awakened in a sleep state. The examples of the present application do not limit the situation where the projection device is awakened.

After determining that the projection device is awakened, the processor can compare the awakened projection angle of the projection device with the reference projection angle to determine whether a difference between the awakened projection angle and the reference projection angle is too large. If the difference between the awakened projection angle and the reference projection angle is too large, it is determined that the awakened projection image of the projection device needs to be corrected. If the difference between the awakened projection angle and the reference projection angle is relatively small, it is determined that the awakened projection image of the projection device does not need to be corrected.

S502: the computing device or the projection device may correct may use the awakened projection image as the projection image when correction is required, and execute the step of correcting a projection image to obtain a reference projection image in response to a correction operation on the projection image.

In the examples of the present application, when it is determined that the projection image of the projection device needs to be corrected, since the awakened projection image has been corrected by the environmental perception algorithm in the awakening process, the processor can directly use the awakened projection image as the projection image and obtain the reference projection image through user's manual adjustment on the projection image. Afterwards, the reference projection image can be directly used as the target projection image. Alternatively, after throw ratio and/or keystone correction is performed on the reference projection image, the throw ratio and/or keystone corrected projection image can be used as the target projection image.

S503: the computing device or the projection device may use the awakened projection image as the target projection image when correction is not required.

In the examples of the present application, when the awakened projection image does not need to be corrected, the awakened projection image has relatively high quality. At this point, the processor can directly use the awakened projection image as the target projection image. That is, when the projection device is awakened, the awakened projection image can be directly projected without correction.

In the above projection image correction method, when the projection device is awakened, whether to correct the awakened projection image of the projection device is determined based on the awakened projection angle and the reference projection angle of the projection device; when correction is required, the awakened projection image is used as the projection image, and the step of correcting a projection image to obtain a reference projection image in response to a correction operation on the projection image is executed; and when correction is not required, the awakened projection image is used as the target projection image. When the projection device is awakened, this method can implement quick comparison and analysis based on the awakened projection angle and reference projection angle of the projection device, to automatically determine to correct the awakened projection image. When correction is required, the awakened projection image is automatically used as the projection image, and the correction operation is performed to obtain the reference projection image. When correction is not required, the awakened projection image is directly used as the target projection image. In this way, a high-quality projection image can be ensured after the projection device is awakened, and user's watching experience can be ensured.

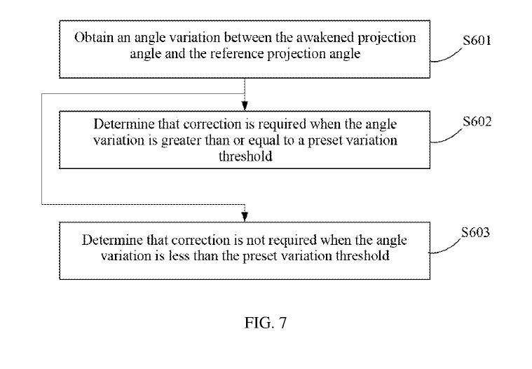

In one example, as shown in FIG. 7, the specific process of determining, based on an awakened projection angle and a reference projection angle of the projection device, whether to correct an awakened projection image of the projection device, is introduced. The specific process may include the following steps.

S601: the computing device or the projection device may obtain an angle variation between the awakened projection angle and the reference projection angle. The awakened projection angle includes an awakened pitch angle, an awakened yaw angle, and an awakened roll angle. The reference projection angle includes a reference pitch angle, a reference yaw angle, and a reference roll angle.

In the examples of the present application, the processor can calculate a difference between each parameter in the awakened projection angle and a corresponding parameter in the reference projection angle, to obtain the angle variation between the awakened projection angle and the reference projection angle. The angle variation includes a pitch angle variation (i.e., a difference between the awakened pitch angle and the reference pitch angle), a yaw angle variation (i.e., a difference between the awakened yaw angle and the reference yaw angle), and a roll angle variation (i.e., a difference between the awakened roll angle and the reference roll angle).

S602: the computing device or the projection device may determine that correction is required when the angle variation is greater than or equal to a preset variation threshold.

In the examples of the present application, “the angle variation is greater than or equal to the preset variation threshold” indicates that any parameter in the angle variation is greater than or equal to a corresponding variation threshold, that is, at least one of the following conditions is satisfied: the pitch angle variation is greater than or equal to a pitch angle variation threshold; the yaw angle variation is greater than or equal to a yaw angle variation threshold; and the roll angle variation is greater than or equal to a roll angle variation threshold. When it is determined that the angle variation is greater than or equal to the preset variation threshold, there is a significant difference between the awakened projection angle and the reference projection angle. At this point, the processor can determine that the awakened projection image needs to be corrected.

S603: the computing device or the projection device may determine that correction is not required when the angle variation is less than the preset variation threshold.

In the examples of the present application, “the angle variation is less than the preset variation threshold” indicates that all parameters in the angle variation are less than the corresponding variation thresholds, that is, all of the following conditions need to be satisfied: the pitch angle variation is less than the pitch angle variation threshold; the yaw angle variation is less than the yaw angle variation threshold; and the roll angle variation is less than the roll angle variation threshold. When it is determined that the angle variation is less than the preset variation threshold, there is a small difference between the awakened projection angle and the reference projection angle. At this point, the processor can determine that the awakened projection image does not need to be corrected.

In the above projection image correction method, the angle variation between the awakened projection angle and the reference projection angle is obtained; when the angle variation is greater than or equal to the preset variation threshold, it is determined that correction is required; and when the angle variation is less than the preset variation threshold, it is determined that correction is not required. By obtaining the angle variation between the awakened projection angle and the reference projection angle and using the preset variation threshold as a limiting condition to compare the angle variation with the preset variation threshold, this method can accurately determine whether the projection image needs to be corrected.

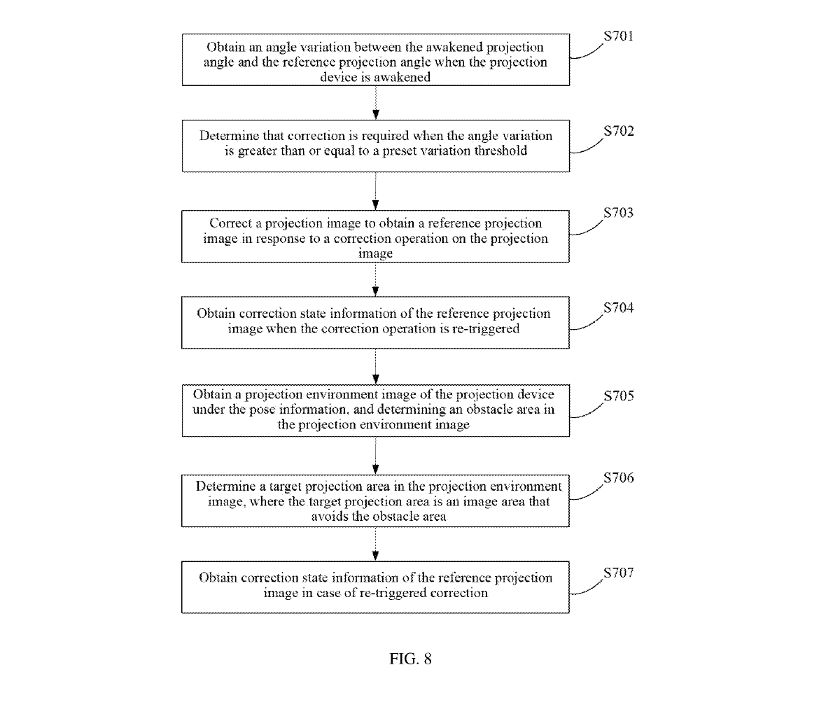

In a specific example, as shown in FIG. 8, the projection image correction method may further includes the following steps.

S701: a computing device or a projection device may obtain an angle variation between the awakened projection angle and the reference projection angle when the projection device is awakened;

S702: the computing device or the projection device may determine that correction is required when the angle variation is greater than or equal to a preset variation threshold;

S703: the computing device or the projection device may correct a projection image to obtain a reference projection image in response to a correction operation on the projection image;

S704: the computing device or the projection device may obtain correction state information of the reference projection image when the correction operation is re-triggered;

S705: the computing device or the projection device may obtain a projection environment image of the projection device under pose information, and determine an obstacle area in the projection environment image;

S706: the computing device or the projection device may determine the target projection area in the projection environment image, where the target projection area is an image area that avoids the obstacle area;

S707: the computing device or the projection device may form a target projection image by projection on a target projection area.

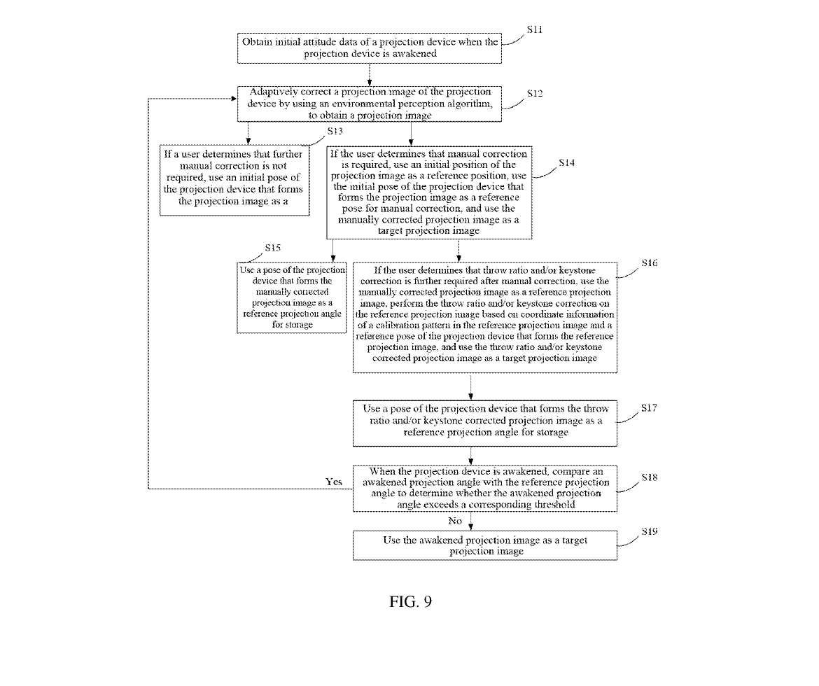

FIG. 9 is a schematic flowchart of a projection image correction method. The method may include: S11: obtaining initial attitude data of a projection device when the projection device is awakened; S12: adaptively correcting a projection image of the projection device by using an environmental perception algorithm, to obtain a projection image; S13: if a user determines that further manual correction is not required, using an initial pose of the projection device that forms the projection image as a reference projection angle for storage; S14: if the user determines that manual correction is required, using an initial position of the projection image as a reference position, using the initial pose of the projection device that forms the projection image as a reference pose for manual correction, and using the manually corrected projection image as a target projection image; S15: using a pose of the projection device that forms the manually corrected projection image as a reference projection angle for storage; S16: if the user determines that throw ratio and/or keystone correction is further required after manual correction, using the manually corrected projection image as a reference projection image, performing the throw ratio and/or keystone correction on the reference projection image based on coordinate information of a calibration pattern in the reference projection image and a reference pose of the projection device that forms the reference projection image, and using the throw ratio and/or keystone corrected projection image as a target projection image; S17: using a pose of the projection device that forms the throw ratio and/or keystone corrected projection image as a reference projection angle for storage; S18: when the projection device is awakened, comparing an awakened projection angle with the reference projection angle to determine whether the awakened projection angle exceeds a corresponding threshold, and performing step S12 if the awakened projection angle exceeds the corresponding threshold, otherwise, performing step S19 if the awakened projection angle does not exceed the corresponding threshold; and S19: using the awakened projection image as a target projection image.

It should be understood that the various steps in the flowcharts involved in the above examples are displayed in sequence indicated by arrows, but these steps are not necessarily executed in such sequence. Unless otherwise explicitly specified herein, these steps are not limited in a strict sequence, but may be executed in other sequences. Moreover, at least some of the steps in the flowcharts involved in the above examples may include a plurality of steps or stages, these steps or stages are not necessarily completed at the same time but may be executed at different time, the execution of these steps or stages is not necessarily sequential, but these steps or stages may be alternately executed with at least part of other steps or stages.

Based on the same inventive concept, an example of the present application further provides a projection image correction apparatus for implementing the projection image correction method mentioned above. The implementation solution provided by this apparatus is similar to the implementation solution described in the above method. Therefore, the specific limitations in one or more examples of the projection image correction apparatus provided below can refer to the limitations of the projection image correction method mentioned above, and will not be repeated here.

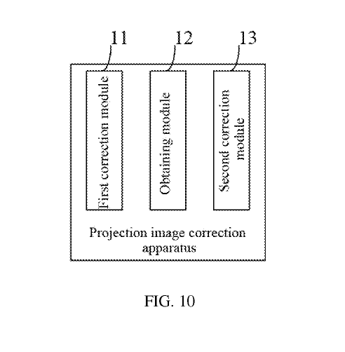

In an exemplary example, as shown in FIG. 10, a projection image correction apparatus is provided, including a first correction module 11, an obtaining module 12, and a second correction module 13. The first correction module 11 may be configured to correct a projection image to obtain a reference projection image in response to a correction operation on the projection image. The obtaining module 12 may be configured to obtain correction state information of the reference projection image when the correction operation is re-triggered. The correction state information may include a throw distance of a target projection area and a projection angle of the projection device, and a method for the re-triggered correction includes throw ratio and/or keystone correction.

The method for the re-triggered correction includes keystone correction, and a situation for the re-triggered correction includes: adjusting the reference projection image, and re-triggering the keystone correction when a change in the projection angle and/or throw distance triggers the correction operation.

The method for the re-triggered correction includes throw ratio correction, and a situation for the re-triggered correction includes: adjusting the reference projection image, and re-triggering the throw ratio correction when a change in the throw distance and/or projection angle triggers the correction operation.

The second correction module 13 may be configured to correct, based on the correction state information, the projection image after re-triggered correction, to obtain a target projection image.

In an exemplary example, the second correction module includes a first determination unit, a second determination unit, and a formation unit, where the first determination unit may be configured to obtain a projection environment image of the projection device under pose information, and determine an obstacle area in the projection environment image; the second determination unit may be configured to determine the target projection area in the projection environment image, where the target projection area is an image area that avoids obstacles; and the formation unit may be configured to form the target projection image by projection on a target projection area.

In an exemplary example, the obtaining module includes a first obtaining unit and a third determination unit, where the first obtaining unit may be configured to obtain an initial pose of the projection device that forms the projection image, and initial coordinate information of a calibration pattern in the projection image; and the third determination unit may be configured to determine coordinate information of a calibration pattern in the reference projection image based on the initial pose, the initial coordinate information, and a reference pose of the projection device that forms the reference projection image.

In an exemplary example, the third determination unit may be further configured to determine a throw distance deviation and an attitude deviation of the projection device based on the initial pose and the reference pose; determine a coordinate deviation of the projection image based on the throw distance deviation and the attitude deviation; and determine the coordinate information of the calibration pattern in the reference projection image based on the coordinate information of the calibration pattern in the projection image and the coordinate deviation of the projection image.

In an exemplary example, the projection image correction apparatus further includes a first determination module, an execution module, and a second determination module, where the first determination module may be configured to determine, based on an awakened projection angle and a reference projection angle of the projection device, whether to correct an awakened projection image of the projection device when the projection device is awakened; the execution module is configured to use the awakened projection image as the projection image when correction is required, and execute the step of correcting a projection image to obtain a reference projection image in response to a correction operation on the projection image; and the second determination module is configured to use the awakened projection image as the target projection image when correction is not required.

In an exemplary example, the first determination module includes a second obtaining unit, a fourth determination unit, and a fifth determination unit, where the second obtaining unit may be configured to obtain an angle variation between the awakened projection angle and the reference projection angle; the fourth determination unit may be configured to determine that correction is required when the angle variation is greater than or equal to a preset variation threshold; and the fifth determination unit may be configured to determine that correction is not required when the angle variation is less than the preset variation threshold.

The various modules in the foregoing projection image correction apparatus can be fully or partially implemented through software, hardware, and a combination thereof. The modules can be embedded in or independent of a processor in a computer device in a form of hardware, or stored in a memory of a computer device in a form of software, whereby the processor calls the modules to perform operations corresponding to the modules.

In one example, a computer device is provided, including a memory and a processor, where the memory stores a computer program, and the processor executes the computer program to implement the content of any example of the foregoing projection image correction method.

In one example, a computer-readable storage medium is provided, storing a computer program that, when executed by a processor, implements the content of any example of the foregoing projection image correction method.

In one example, a computer program product is provided, including a computer program that, when executed by a processor, implements the content of any example of the foregoing projection image correction method.

It should be noted that the user information (including but not limited to user equipment information, user personal information, etc.) and data (including but not limited to data used for analysis, stored data, displayed data, etc.) involved in the present application are all authorized by the user or fully authorized by all parties, and the collection, use, and processing of relevant data comply with relevant regulations.

A person of ordinary skill in the art can understand that all or some of the processes in the methods of the foregoing examples can be implemented by a computer program (e.g., a computing device) instructing relevant hardware. The computer program can be stored in a non-volatile computer-readable storage medium. The computer program, when executed, can include the processes of the examples of the above methods. Any reference to the memory, database, or other media used in each example provided by the present application may include at least one of a non-volatile memory and a volatile memory. The non-volatile memory may be a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may be a random access memory (RAM), an external cache, or the like. As an illustration and not a limitation, the RAM may be in various forms, such as a static random access memory (SRAM) or a dynamic random access memory (DRAM). The database involved in each example provided by the present application may include at least one of a relational database and a non-relational database. The non-relational database may include, but is not limited to, a blockchain-based distributed database and the like, without limitation herein. The processor involved in the various examples provided in the present application may be a general-purpose processor, a central processing unit, a graphics processing unit, a digital signal processor, a programmable logic device, a quantum computing–based data processing logic device, an artificial intelligence (AI) processor, etc., without limitation herein.

The technical features of the above examples can be combined in any way. To make the description concise, not all possible combinations of the technical features in the foregoing examples are described. However, as long as there is no contradiction in the combinations of these technical features, these combinations fall within the scope of the present application.

The above examples merely express several implementations of the present application, and their descriptions are more specific and detailed, but should not be understood as limiting the patent scope of the present application. It should be noted that a person of ordinary skill in the art may make variations and improvements without departing from the concept of the present application, and these variations and improvements all fall into the scope of protection of the present application. Therefore, the scope of protection of the present application should be subject to the appended claims.

What is claimed is:

1. A method for projection image correction, comprising:
capturing, by a projection device, a reference projection image in response to a correction operation on a projection image;
storing, by the projection device, correction state information of the reference projection image after determining that the correction operation is re-triggered;
generating, by the projection device, based on the stored correction state information, and the projection image after re-triggered correction, a target projection image; and
projecting, by the projection device and on a projection plane, the target projection image.

2. The method of claim 1, wherein the correction state information comprises a throw distance of a target projection area and a projection angle of the projection device, and the correction operation is re-triggered by a change in the correction state information comprising at least one of a throw ratio or a keystone correction.

3. The method of claim 1, wherein the re-triggered correction operation comprises a keystone correction, and the re-triggered correction comprises:
adjusting the reference projection image; and
re-triggering the keystone correction when a change in at least one of a projection angle or a throw distance triggers the correction operation.

4. The method of claim 1, wherein the re-triggered correction operation comprises a throw ratio correction, and the re-triggered correction comprises:
adjusting the reference projection image, and re-triggering the throw ratio correction when a change in at least one of a throw distance or a projection angle triggers the correction operation.

5. The method of claim 2, wherein the projection angle comprises pose information of the projection device, and the generating the target projection image comprises:
obtaining a projection environment image of the projection device under the pose information, and determining an obstacle area in the projection environment image;
determining the target projection area in the projection environment image, wherein the target projection area is an image area that avoids the obstacle area; and
forming the target projection image by projection on the target projection area.

6. The method of claim 2, wherein the correction state information further comprises coordinate information of a calibration pattern in the reference projection image, and the projection angle comprises pose information of the projection device;
the storing the correction state information of the reference projection image comprises:
obtaining an initial pose of the projection device that forms the projection image, and initial coordinate information of a calibration pattern in the projection image; and
determining the coordinate information of the calibration pattern in the reference projection image based on the initial pose, the initial coordinate information, and a reference pose of the projection device that forms the reference projection image.

7. The method of claim 6, wherein the determining the coordinate information of the calibration pattern in the reference projection image comprises:
determining a throw distance deviation and an attitude deviation of the projection device based on the initial pose and the reference pose;
determining a coordinate deviation of the projection image based on the throw distance deviation and the attitude deviation; and
determining the coordinate information of the calibration pattern in the reference projection image based on the coordinate information of the calibration pattern in the projection image and the coordinate deviation of the projection image.

8. The method of claim 1, further comprising:
determining, based on an awakened projection angle and a reference projection angle of the projection device, whether to correct an awakened projection image of the projection device when the projection device is awakened;
using the awakened projection image as the projection image when correction is required, and executing the step of correcting a projection image to obtain the reference projection image in response to the correction operation on the projection image; and
using the awakened projection image as the target projection image when correction is not required.

9. The method of claim 8, wherein the determining whether to correct the awakened projection image of the projection device comprises:
obtaining an angle variation between the awakened projection angle and the reference projection angle;
determining that correction is required when the angle variation is greater than or equal to a preset variation threshold; and
determining that correction is not required when the angle variation is less than the preset variation threshold.

10. A projection device, comprising:
one or more processors; and
memory storing non-transitory computer-readable instructions that, when executed by the one or more processors of the projection device, configure the projection device to:
capture a reference projection image in response to a correction operation on a projection image;
store correction state information of the reference projection image after determining that the correction operation is re-triggered;
generate, based on the stored correction state information, and the projection image after re-triggered correction, a target projection image; and
project, on a projection plane, the target projection image.

11. The projection device of claim 10, wherein the correction state information comprises a throw distance of a target projection area and a projection angle of the projection device, and the correction operation is re-triggered by a change in the correction state information comprising at least one of a throw ratio or a keystone correction.

12. The projection device of claim 10, wherein the re-triggered correction operation comprises a keystone correction, and wherein the computer-readable instructions, when executed by the one or more processors, further cause the projection device to re-trigger the correction operation by:
adjusting the reference projection image, and re-triggering the keystone correction when a change in at least one of a projection angle or a throw distance triggers the correction operation.

13. The projection device of claim 10, wherein the re-triggered correction operation comprises a throw ratio correction, and wherein the computer-readable instructions, when executed by the one or more processors, further cause the projection device to re-trigger the correction operation by:
adjusting the reference projection image, and re-triggering the throw ratio correction when a change in at least one of a throw distance or a projection angle triggers the correction operation.

14. The projection device of claim 11, wherein the projection angle comprises pose information of the projection device, and wherein the computer-readable instructions, when executed by the one or more processors, further cause the projection device to generate the target projection image by:
obtaining a projection environment image of the projection device under the pose information, and determining an obstacle area in the projection environment image;
determining the target projection area in the projection environment image, wherein the target projection area is an image area that avoids the obstacle area; and
forming the target projection image by projection on the target projection area.

15. The projection device of claim 11, wherein the correction state information further comprises coordinate information of a calibration pattern in the reference projection image, and the projection angle comprises pose information of the projection device; and
wherein the computer-readable instructions, when executed by the one or more processors, further cause the projection device to store the correction state information of the reference projection image by:
obtaining an initial pose of the projection device that forms the projection image, and initial coordinate information of a calibration pattern in the projection image; and
determining the coordinate information of the calibration pattern in the reference projection image based on the initial pose, the initial coordinate information, and a reference pose of the projection device that forms the reference projection image.

16. The projection device of claim 15, wherein the computer-readable instructions, when executed by the one or more processors, further cause the projection device to determine the coordinate information of the calibration pattern in the reference projection image by:
determining a throw distance deviation and an attitude deviation of the projection device based on the initial pose and the reference pose;
determining a coordinate deviation of the projection image based on the throw distance deviation and the attitude deviation; and
determining the coordinate information of the calibration pattern in the reference projection image based on the coordinate information of the calibration pattern in the projection image and the coordinate deviation of the projection image.

17. The projection device of claim 10, wherein the computer-readable instructions, when executed by the one or more processors, further cause the projection device to:
determine, based on an awakened projection angle and a reference projection angle of the projection device, whether to correct an awakened projection image of the projection device when the projection device is awakened;
use the awakened projection image as the projection image when correction is required, and executing the step of correcting a projection image to obtain the reference projection image in response to the correction operation on the projection image; and
use the awakened projection image as the target projection image when correction is not required.

18. The projection device of claim 17, wherein the computer-readable instructions, when executed by the one or more processors, further cause the projection device to determine whether to correct the awakened projection image of the projection device by:
obtaining an angle variation between the awakened projection angle and the reference projection angle;
determining that correction is required when the angle variation is greater than or equal to a preset variation threshold; and
determining that correction is not required when the angle variation is less than the preset variation threshold.

19. A system comprising:
a projection device; and
a controller comprising:
one or more processors; and
memory storing non-transitory computer-readable instructions that, when executed by the one or more processors, cause the controller to:
send, to the projection device, a first instruction to capture a reference projection image in response to a correction operation on a projection image;
store correction state information of the reference projection image after determining that the correction operation is re-triggered;
generate, based on the stored correction state information and the projection image after re-triggered correction, a target projection image; and
send, to the projection device, a second instruction to project, on a projection plane, the target projection image.

20. The system of claim 19, wherein the correction state information comprises a throw distance of a target projection area and a projection angle of the projection device, and the correction operation is re-triggered by a change in the correction state information comprising at least one of a throw ratio or a keystone correction.
